(19) United States
(12) Patent Application Publication
(10) Pub. No.: US 2025/0303767 A1
(43) Pub. Date: Oct. 2, 2025

(54) PRINTING SYSTEM AND IMAGING DATA STORAGE PROGRAM

(71) Applicant: SEIKO EPSON CORPORATION, Tokyo (JP)

(72) Inventor: Eishin YOSHIKAWA, Matsumoto (JP)

(21) Appl. No.: 19/087,702

(22) Filed: Mar. 24, 2025

(30) Foreign Application Priority Data
Mar. 26, 2024 (JP) 2024-049145

(51) Int. Cl. B41J 29/393; B41J 3/46; H04N 23/60; H04N 23/63

(52) U.S. Cl. CPC B41J 29/393; B41J 3/46; H04N 23/632; H04N 23/635; H04N 23/64; B41J 2029/3935

(57) ABSTRACT

A printing system 10 includes a printing device 20 and an information terminal 30. The test pattern includes a ruled line pattern KP, a gradation pattern VP, and direction display patterns DPF and DPR that indicates at least one of a near-side and a far-side in a first direction. In the first direction, the ruled line pattern KP and the gradation pattern VP do not overlap, the ruled line pattern KP is arranged on the near-side in the first direction, and the gradation pattern VP is arranged on the far-side.

The present application is based on, and claims priority from JP Application Serial Number 2024-049145, filed Mar. 26, 2024, the disclosure of which is hereby incorporated by reference herein in its entirety.

### BACKGROUND

### 1. Technical Field

The present disclosure relates to a printing system and an imaging data storage program, and particularly to a printing system including a printing device having a printing head and an imaging data storage program.

### 2. Related Art

In general, adjustment is essential for mechanical devices, and this is no exception for inkjet printers, which are printing devices. The affect of adjustment accuracy on image quality is significant in inkjet printers. If the printer is not adjusted correctly, the desired image quality cannot be obtained. The ink jet printer can print a predetermined test pattern for adjustment. The mechanical elements of the inkjet printer can be adjusted by correcting the print data based on the result of the user visually inspecting the printed test pattern.

However, when a general user is the main person making adjustments, even if a test pattern is prepared, it is difficult to judge it correctly. Therefore, it may not be possible to adjust it correctly and the desired image quality may not be obtained. In other words, it is necessary to make the adjustments correctly, but at the same time it can also be said to be difficult. To compensate for this, some printing devices are equipped with a dedicated sensor to read the test pattern, and adjustments are made using this sensor. However, a dedicated sensor is expensive, and the size of the mechanical body becomes larger to accommodate the sensor.

For this reason, in the related art, a method disclosed in JP-A-2006-121486 is known as a method that improves adjustment accuracy. The technique disclosed in JP-A-2006-121486 uses an imaging device such as a digital camera that is separate from the printing device. The printing device prints a test pattern, and the imaging device captures an image of the test pattern. The printing device generates print correction data based on the captured image data.

When an imaging device separate from a printing device is used as in the related art, there is a high possibility that a shadow of the imaging device will be captured when the test pattern is captured. In the captured image of the test pattern with the shadow reflected, the image data is acquired with a different gradation value from the original gradation value, and correct print correction data cannot be obtained. Imaging devices such as digital cameras have a light source, but when capturing an image of the adjustment pattern, the distance between the light source and the adjustment pattern is short because the distance is short, so it is likely that a gradient of illuminance will occur. Therefore, such a light source cannot be used because there will be a large variation depending on the position of the light source. In other words, it is necessary to capture the adjustment pattern using a peripheral light source, but as described above, there is a high possibility that shadows will be reflected.

### SUMMARY

A printing system includes a printing device having a printing head and an information terminal having an imaging section that captures an image of a test pattern formed by the printing device in order to correct a printing characteristic of the printing device, wherein the test pattern has a ruled line pattern, a gradation pattern, and a direction display pattern that indicates at least one of near-side and far-side in a first direction, in the first direction, the ruled line pattern and the gradation pattern do not overlap, and in the first direction, the ruled line pattern is arranged on the near-side, and the gradation pattern is arranged on the far-side.

A non-transitory computer readable storage medium storing an imaging data storage program for storing to a predetermined region image data of a test pattern, which is formed by a printing device, captured by an imaging section of an information terminal, in order to correct a printing characteristic of the printing device having a printing head, the test pattern including a ruled line pattern and a gradation pattern, the program causing to execute a first function that determines that the ruled line pattern and the gradation pattern of the test pattern do not overlap in a predetermined first direction of an imaging range of the imaging section, a second function that determines that the ruled line pattern is arranged on near-side and the gradation pattern is arranged on far-side in the predetermined first direction, and a function that stores the image data in predetermined region when the conditions of both the first function and the second function are satisfied.

### BRIEF DESCRIPTION OF THE DRAWINGS

FIG. 1 is a schematic diagram of a printing system according to an embodiment of the present disclosure.

FIG. 2 is a schematic block diagram of a printing device and a information terminal.

FIG. 3 is a diagram showing a test pattern and image data.

FIG. 4 is a flowchart of a printing program for a test pattern.

FIG. 5 is a flow chart of a program for generating print correction data.

FIG. 6 is a diagram showing a test pattern of a modified example.

FIG. 7 is a flowchart of an imaging program of the information terminal.

FIG. 8 is a diagram showing a display example of the frame section on the display section.

FIG. 9 is a flowchart of an imaging program of a modified example of the information terminal.

FIG. 10 is a view showing a display example of the frame section on the display section.

### DESCRIPTION OF EMBODIMENTS

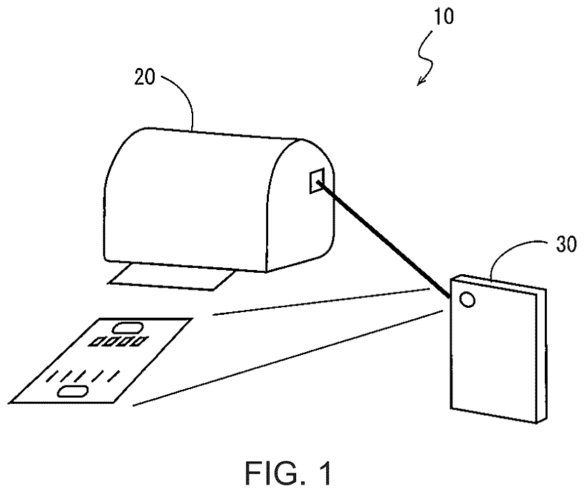

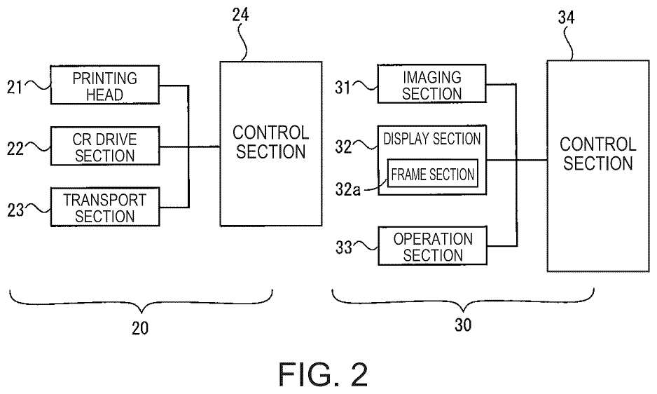

Hereinafter, embodiments of the present disclosure will be described based on the drawings. FIG. 1 is a schematic view showing a printing system according to an embodiment of the present disclosure. FIG. 2 is a schematic block diagram showing a printing device and an information terminal. In FIGS. 1 and 2, the printing system 10 has a printing device 20 and an information terminal 30, and the printing device 20 and the information terminal 30 are electrically connected to each other via a predetermined connection cable. The printing device 20 and the information terminal 30 may be connected not only by wire but also wirelessly or indirectly through a network or the like.

The printing device 20 is an ink jet printer, and is equipped with a print head 21 that ejects ink droplets, a CR drive section 22 that causes the print head 21 to reciprocate, a transport section 23 that transports a print medium, a control section 24 which controls these sections, and the like. When the control section 24 receives print data, the control section 24 controls the print head 21, the CR drive section 22, and the transport section 23 to perform printing on the print medium. The control section 24 can also cause the printer to print a predetermined test pattern for adjustment, and can also generate print correction data based on image data from when the test pattern was captured.

The information terminal 30 is an information processing device represented by a smartphone or the like, and is equipped with an imaging section 31 with an imaging element that has a predetermined resolution, a display section 32 that displays an imaging range of the imaging section, an operation section 33, and a control section 34 that performs various controls. By operating the operation section 33, the information terminal 30 can capture an image of a subject with the imaging section 31 and output it as image data. The control section 34 can display various messages on the display section 32 based on the captured image of the subject, and can display the frame section 32a at a specific location on the display section 32.

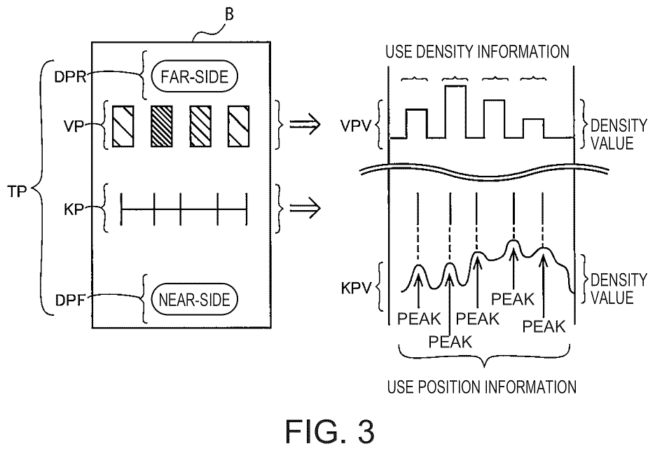

FIG. 3 shows a test pattern and image data. The test pattern TP, which the control section 24 of the printing device 20 causes to print on the print medium B, includes a near-side direction display pattern DPF, a ruled line pattern KP, a gradation pattern VP, and a far-side direction display pattern DPR. The near-side direction display pattern DPF and the far-side direction display pattern DPR are direction display patterns indicating a side of the near-side and a side of the far-side when the test pattern TP is captured by the information terminal 30. The near-side direction display pattern DPF is located close to the side of the near-side, and the far-side direction display pattern DPR is located close to the side of the far-side.

In the present embodiment, both the near-side direction display pattern DPF and the far-side direction display pattern DPR are printed, but it is possible to indicate the direction from the near-side to the far-side (referred to as a first direction) with only one of them, and it is also possible to print only one of them. Also, the shape of the pattern is free, so when changing the shape, it is sufficient to disclose in a manual or similar document, “which pattern indicates the near-side.”

Assuming that this first direction is a reference, the ruled line pattern KP is arranged on the near-side, and the gradation pattern VP is arranged on the far-side. In addition, when the first direction is used as the reference, the ruled line pattern KP and the gradation pattern VP do not overlap. The ruled line pattern KP is a pattern that is basically formed by multiple lines. When analyzing the image data, a density value is used. The ruled line density value KPV obtained by capturing an image of the ruled line pattern KP shows a change as shown in FIG. 3. When analyzing the ruled line density value KPV, a peak portion compared with the peripheral region is recognized as a position of the ruled line. It uses position information. In this case, it is the peak value when compared with the peripheral region, so even if the ruled line exists in a location where a shadow is reflected, the peak portion in the shadow can be accurately recognized. Of course, the peak portion of the ruled line in a location where there is no shadow can also be recognized accurately.

The gradation pattern VP is a pattern formed by multiple patches of rectangular shape. The density of each patch is different from the others. As shown in FIG. 3, the gradation density value VPV obtained by capturing the gradation pattern becomes a constant density value within a predetermined range of each patch section, and a portion other than the patch sections becomes a density value corresponding to a density of the background of the print medium. It uses density value information. In a case where a shadow is reflected on the pattern, the density value will change between a portion where the shadow is not reflected and a portion where the shadow is reflected. So it is necessary to capture the image so that the shadow is not reflected on it.

In this way, by laying out the test pattern separately for the near-side, where the shadow is likely to be reflected, and for the far-side, where the shadow is unlikely to be reflected, it is possible to suppress affect of the shadow on the imaging result of the test pattern. In other words, the ruled line pattern, which is arranged on the near-side, only needs to let one know the on and off status of dots and the coordinates of the dots, so even if it is detected as being slightly darker due to the affect of the shadow, it is possible to make adjustments. Thus, the ruled line pattern is arranged on the near-side. Then, by arranging the gradation pattern to be checked for density on the far-side, it is possible to make it difficult for the shadow to overlap with the gradation pattern. In addition, by making it possible to know which side is the near-side and which side is the far-side when capturing the image, it is possible to suppress capturing the image in the incorrect direction. When capturing the image, the user can determine which side should be the near-side and which side should be the far-side by looking at the test pattern. Therefore, the user can suppress the extra memory consumption and time spent on adjustment by capturing the image in the wrong direction.

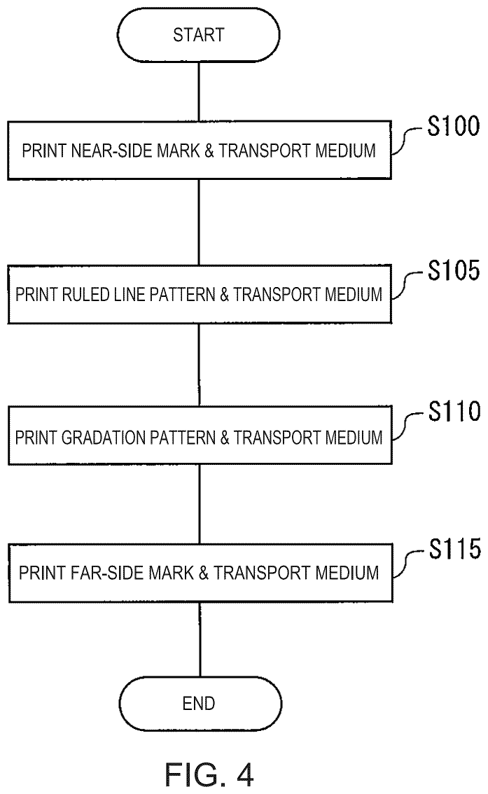

FIG. 4 is a flowchart showing a printing program of the test pattern. The test pattern is printed by the control section 24 of the printing device 20 executing a predetermined printing program. In the following description, the control section 24 controls the print head 21, the CR drive section 22, and the transport section 23 to print the test pattern on the print medium. First, in step S100, the “near-side mark DPF” is printed on the print medium, and the print medium is transported. Thereafter, in step S105, the ruled line pattern KP is printed and then the print medium is transported, in step S110, the gradation pattern VP is printed and then the print medium is transported, and in step S115, the far-side mark DPR is printed and then the print medium is transported. The test pattern as shown in FIG. 2 can be printed by sequentially printing and transporting the medium.

In this way, the test pattern has the ruled line pattern KP, the gradation pattern VP, and the direction display patterns DPF and DPR indicating at least one of the near-side and the far-side in the first direction. The ruled line pattern KP and the gradation pattern VP do not overlap each other in the first direction. The ruled line pattern KP is arranged on the near-side in the first direction, and the gradation pattern VP is arranged on the far-side in the first direction.

When capturing the image of the test pattern using the information terminal 30, it captures it so that the near-side mark DPF is located in the near-side in the field of view, and the far-side mark DPR is located in the far-side in the field of view. At this time, a light source of the information terminal 30, for example, a flash function, is not used, and ambient lighting is used. In order to capture the image of this test pattern as large as possible within the field of view of the information terminal 30, it is necessary to bring the information terminal 30 close to the test pattern to some extent, but it is desirable to avoid reflecting the shadow of the information terminal 30 on the test pattern at this time. However, in reality, there is a high possibility that shadows will be reflected. The shadow often falls on a relatively close portion of the test pattern.

As described above, in this test pattern, the ruled line pattern KP is printed in the near-side and its position information is acquired, so it is less affected by the shadow reflected on it. In addition, the portion of the gradation pattern VP, which is located in the far-side, is far from the information terminal 30, so it is difficult for the shadow to enter the portion of the gradation pattern VP. Therefore, even if the density value information is acquired, it is not easily affected by the shadow.

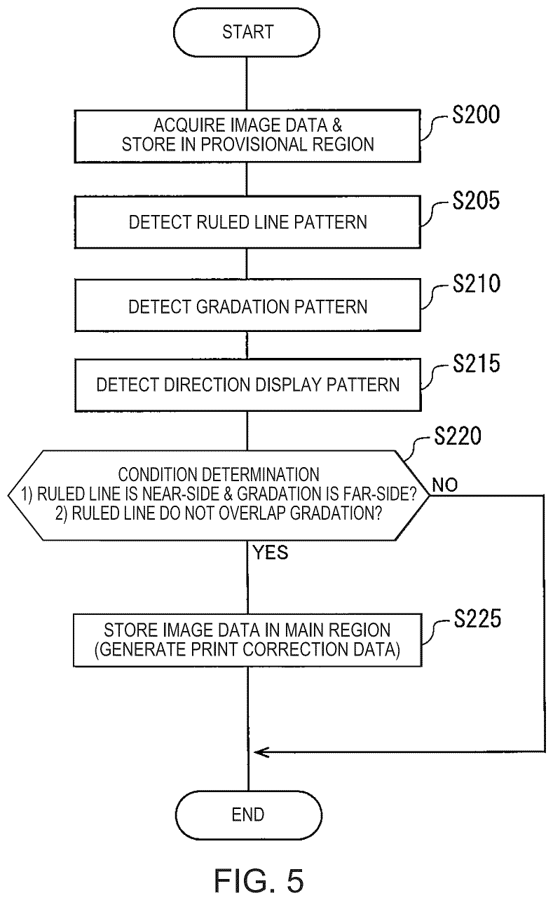

FIG. 5 is a flowchart showing a program for generating print correction data. The control section 24 of the printing device 20 acquires the image data captured by the information terminal 30, analyzes the test pattern, and generates print correction data. In step S200, the control section 24 acquires the image data and stores it in a provisional region. The provisional region is a temporary region, and the image data in this region is not used to generate the print correction data. Next, the control section 24 detects the ruled line pattern KP in step S205, detects the gradation pattern VP in step S210, and detects the direction display patterns DPF and DPR in step S215. Details of these detection processes are omitted. As an example, it is possible to make it easier to specify a region by printing a reference marker for position detection around each pattern.

The control section 24 performs a following condition determination in step S220.
1) Is the ruled line pattern KP located in the near-side in the image data, and is the gradation pattern VP located in the far-side in the image data?
2) Does the ruled line pattern KP not overlap with the gradation pattern VP?

Since each region is being specified and the direction from the near to the far (corresponding to the first direction) that is determined by the position of the direction display pattern is determined, it is possible to perform the condition determination of 1) and 2). If both of the condition determinations are positive, the control section 24 stores the image data in the main region in step S225. By storing the image data in the main region, the control section 24 can generate the print correction data using this image data.

If both of the condition determinations are not positive, the image data is not stored in the main region, and the control section 24 cannot generate the print correction data using this image data. This is because if it is not confirmed that the ruled line pattern KP is located on the near-side, the possibility that the shadow is reflected in the gradation pattern VP cannot be excluded, so it is not desirable to generate the print correction data.

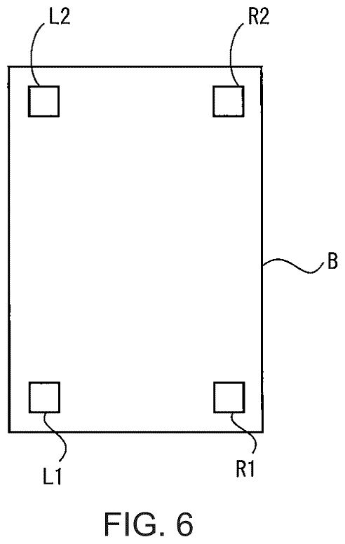

FIG. 6 shows a test pattern of a modified example. The direction display pattern only needs to be able to detect the first direction. In this example, an ArUco marker, which is an example of a position recognition marker (AR marker), is printed on the four corners L1, R1, L2, and R2 of the print medium. In this case, the markers arranged at L1 and R1 indicate the near-side, and the markers arranged at L2 and R2 indicate the far-side. The direction display pattern need not be one on the near-side and one on the far-side. It may be multiple, or it may be one that displays the front, rear, left, and right direction with a single pattern.

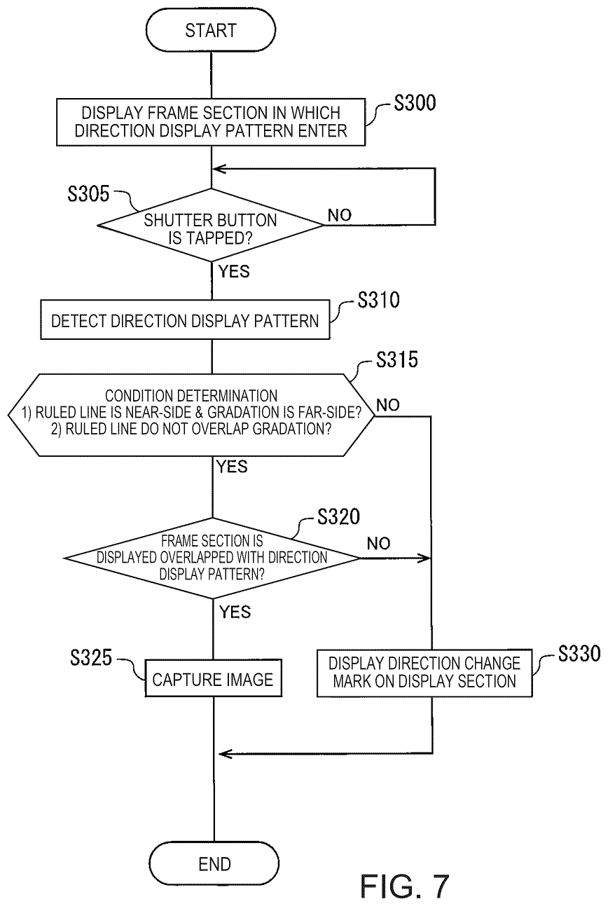

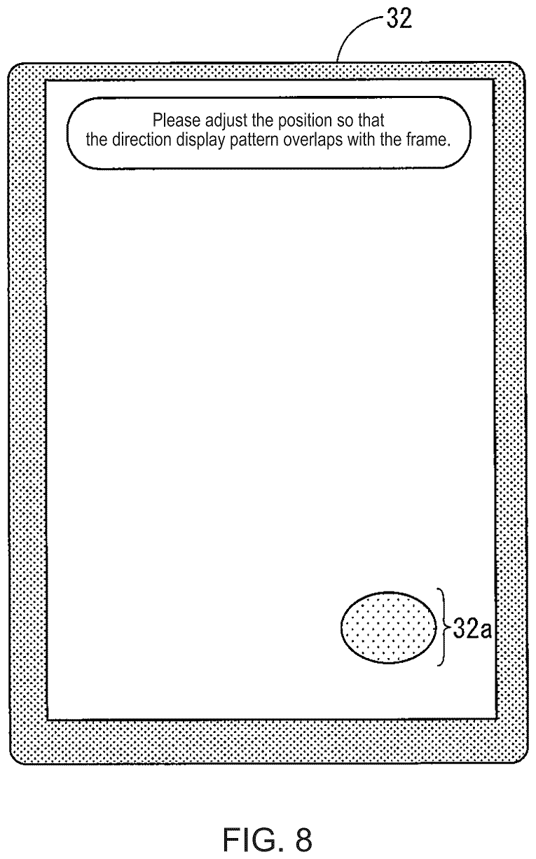

FIG. 7 shows a flowchart of an imaging program of the information terminal, and FIG. 8 shows an example of a frame section displayed on the display section. When the general user captures the image of the test pattern with the information terminal 30, it is necessary to recognize the direction display pattern and to capture the image in the correct direction. It is desirable to ensure such an image capturing condition.

When the general user starts the camera application on the information terminal 30, which is a smartphone, the control section 34 displays the frame section 32a in which the direction display patterns DPF and DPR will be positioned, on the display section 32 in step S300, as shown in FIG. 8. The frame section 32a indicating a place in which the direction display pattern will be positioned corresponds to a second frame section. At this time, as shown in FIG. 8, it is also possible to display a message such as “Please adjust the position where the direction display pattern overlaps with the frame” in a margin such as an upper part of the display section 32. By reading this message, the general user adjusts the position so that the direction display patterns DPF and DPR enter the frame section 32a and then taps the shutter button. The control section 34 of the information terminal 30, in step S305, recognizes that the shutter button is tapped and, in step S310, detects the direction display pattern. The image of the direction display pattern may be recognized or the above-described position marker may be used. Only the image within the frame section 32a may be recognized.

After detecting the direction display pattern, the control section 34 performs the following condition determination in step S315.
1) Is the ruled line pattern KP located in the near-side in the image data, and is the gradation pattern VP located in the far-side in the image data? (corresponding to a second function)
2) Does the ruled line pattern KP not overlap with the gradation pattern VP? (corresponding to a first function)

If both of the condition determinations are positive, the control section 34, in step S320, confirms that the frame section 32a is displayed overlapped with the direction display pattern, and, in step S325, performs imaging. By performing the imaging, image data is generated and stored in a predetermined region. The region where stored may be the printing device 20 or a predetermined region on a network. By determining whether or not the frame section 32a is displayed overlapped with the direction display pattern, it is possible to inform the general user that the direction display pattern has important meaning.

If the information terminal 30 has a program that releases the shutter when the ruled line pattern is located on the near-side and the gradation pattern is located on the far-side, it can suppress an occurrence where the image is captured with the shadow overlapping the gradation pattern VP of the test pattern. Performing the condition determinations 1) and 2) and saving the image data in a predetermined region is not limited to just the imaging program on the information terminal 30. It may be an imaging data storage program executed in the printing device 20 or an imaging data storage program executed on a network.

In this way, this imaging data storage program, in order to correct the printing characteristics of the printing device 20 with a printing head, causes the image data of the test pattern that was formed by the printing device 20 and that includes the ruled line pattern KP and the gradation pattern VP to be stored in the predetermined region. The image data was captured by the imaging section 31 of the information terminal 30. This imaging data storage program causes to execute the first function that determines that the ruled line pattern KP and the gradation pattern VP of the test pattern do not overlap in a predetermined first direction of the imaging range of the imaging section 31, a second function that determines that the ruled line pattern KP is located on the near-side and the gradation pattern VP is located on the far-side in the predetermined first direction, and a function that stores the image data in a predetermined region when both conditions of the first function and the second function are satisfied.

Note that in this case, the test pattern may not include a “direction display pattern indicating which is the near-side or far-side.”

The information terminal 30 is equipped with the display section 32 that displays the imaging range of the imaging section 31, and the display section 32 displays a second frame section 32a that indicates the position where the direction display patterns DPF and DPR are to be located within the imaging range. In the first direction of the imaging range of the imaging section 31, the ruled line pattern KP and the gradation pattern VP of the test pattern do not overlap, the ruled line pattern KP is located on the near-side in the first direction, and the gradation pattern VP is located on the far-side. The information terminal 30 captures the image by the imaging section 31 when the second frame section 32a and the direction display patterns DPF and DPR overlap.

In this way, by indicating a location in the imaging range where the direction display patterns DPF and DPR of the test pattern should be placed and by releasing the shutter when these conditions are satisfied, it is possible to obtain the imaging data of the test pattern with reduced shadow affect. As a result, it is possible to suppress the possibility that the correction is executed based on the imaging data of the test pattern affected by shadow.

If both of the condition determinations are not positive, in step S330, the control section 34 displays a direction change mark on the display section 32. Since the general user may not recognize the importance of the direction to capture the image, by notifying the user to change the direction on the display section of the information terminal 30, the user will be able to capture the image in the correct direction. The direction change mark may be a mark indicating the rotation direction or a message in text urging the user to change the direction. In this way, when the arrangement of the ruled line pattern and the gradation pattern included in the imaging range is incorrect, the display section 32 displays the correct imaging direction or the message indicating the imaging direction is incorrect.

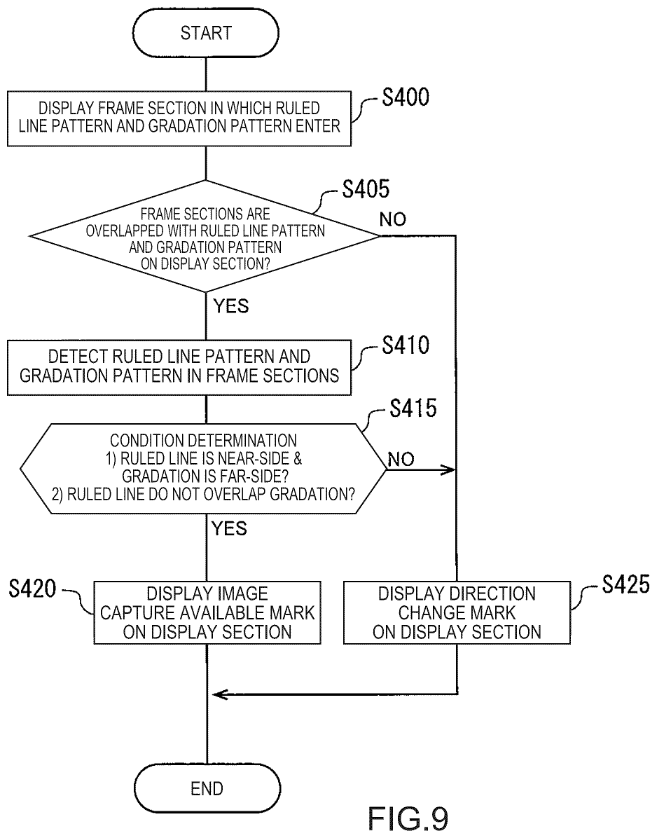

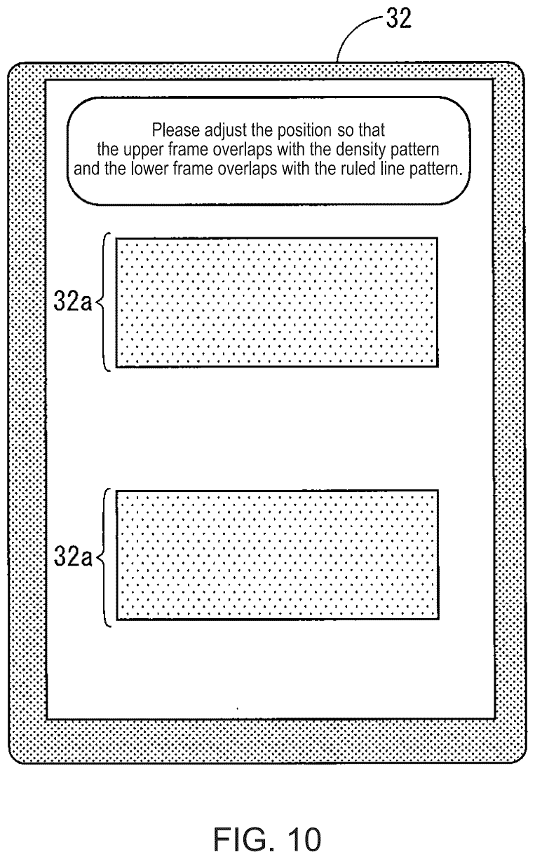

FIG. 9 shows a flowchart of an imaging program for a modified example of the information terminal, and FIG. 10 shows an example of the frame section in the display section. It is assumed that a general user starts a camera application on the information terminal 30, which is a smartphone, and faces the information terminal 30 so that the test pattern enters the field of view of the imaging section 31. In step S400, as shown in FIG. 10, the control section 34 of the information terminal 30 displays, on the display section 32, frame sections 32a in which the ruled line pattern KP and the gradation pattern VP should be entered. At this time, as shown in FIG. 10, it is also possible to display a message in the margin, such as the upper part of the display section 32, such as “please adjust the position so that the upper frame overlaps the density pattern and the lower frame overlaps the ruled line pattern”. In step S405, the control section 34 determines whether the frame sections 32a are being displayed overlapped with the ruled line pattern KP and the gradation pattern VP on the display section 32. These frame sections 32a correspond to a first frame section.

The detection of the position of each pattern is performed by the above-described method. By displaying the frame sections 32a in which the ruled line pattern KP and the gradation pattern VP should be entered in advance, the general user can correctly enter the importance of the test pattern in the field of view. Note that the frame sections 32a may be a frame-like shape that is separate for each of the ruled line pattern KP and the gradation pattern VP, or it may be a hole that surrounds the ruled line pattern KP and the gradation pattern VP, and it can be modified as appropriate.

If they are being displayed overlapped, in step S410, the control section 34 detects the ruled line pattern KP and the gradation pattern VP in the frame sections 32a, and performs the following condition determination in step S415.
1) Is the ruled line pattern KP located in the near-side in the image data, and is the gradation pattern VP located in the far-side in the image data?
2) Does the ruled line pattern KP not overlap with the gradation pattern VP?

If both of the condition determinations are positive, the control section 34 displays a mark indicating that imaging is possible on the display section 32 in step S420. In other words, based on the content of the image in the field of view before the general user taps the shutter button, it is analyzed whether or not the important part of the test pattern is in the predetermined position. Then, when both patterns are included and also the imaging direction is correct, then a mark indicating that imaging is possible is displayed on the display section 32, so the general user may tap the shutter button at this point. The mark indicating that imaging is possible may be a mark or a message.

In this way, the information terminal 30 is equipped with the display section 32 that displays the imaging range of the imaging section 31. The display section 32 displays the first frame sections 32a that indicate positions where the gradation pattern VP and the ruled line pattern KP are to be located within the imaging range. In the first direction of the imaging range of the imaging section 31, the ruled line pattern KP and gradation pattern VP of the test pattern do not overlap, the ruled line pattern KP is arranged on the near-side in the first direction, and the gradation pattern VP is arranged on the far-side in the first direction. The imaging section 31 captures the image when the first frame sections 32a overlap with the gradation pattern VP and the ruled line pattern KP.

By indicating a location in the imaging range where the test pattern (the gradation pattern VP and the ruled line pattern KP) should be placed and by releasing the shutter when these conditions are satisfied, it is possible to obtain the imaging data of the test pattern with reduced shadow affect.

However, even if both patterns are included, if the condition determination is not positive, the control section 34, in step S425, displays the direction change mark on the display section 32. The general user can recognize that the imaging direction is not correct at this point. If the user changes the imaging direction as it is, the control section 34 continues to execute the condition determination, and displays the mark indicating that image is possible when the condition determination becomes positive.

Needless to say, the present disclosure is not limited to the above-described embodiments. Needless to say for a person of ordinary skill in the art, the following is disclosed as an example of the present embodiment.
The mutually replaceable members and configurations disclosed in the above-mentioned embodiments are applied by appropriately changing the combinations thereof.
The members and configurations which are publicly known and can be mutually replaced with the members and configurations disclosed in the above-mentioned embodiments are appropriately replaced, and the combinations thereof are changed and applied, although not disclosed in the above-mentioned embodiments.
The members and configurations which can be assumed as substitutes for the members and configurations disclosed in the above-mentioned embodiments by a person skilled in the art based on the publicly known techniques are appropriately replaced, and the combinations thereof are changed and applied.

What is claimed is:

1. A printing system comprising:
a printing device having a printing head and
an information terminal having an imaging section that captures an image of a test pattern formed by the printing device in order to correct a printing characteristic of the printing device, wherein
the test pattern has a ruled line pattern, a gradation pattern, and a direction display pattern that indicates at least one of near-side and far-side in a first direction,
in the first direction, the ruled line pattern and the gradation pattern do not overlap, and
in the first direction, the ruled line pattern is arranged on the near-side, and the gradation pattern is arranged on the far-side.

2. The printing system according to claim 1, wherein
the information terminal has a display section that displays an imaging range of the imaging section and
when an arrangement of the ruled line pattern and the gradation pattern included in the imaging range is incorrect, the display section displays a correct imaging direction or the fact that the imaging direction is incorrect.

3. A non-transitory computer readable storage medium storing an imaging data storage program for storing, in a predetermined region, image data of a test pattern that was formed by a printing device, the image data having been captured by an imaging section of an information terminal, in order to correct a printing characteristic of the printing device having a printing head, the test pattern including a ruled line pattern and a gradation pattern, the program causing to execute:
a first function that determines that the ruled line pattern and the gradation pattern of the test pattern do not overlap in a predetermined first direction of an imaging range of the imaging section;
a second function that determines that the ruled line pattern is arranged on near-side and the gradation pattern is arranged on far-side in the predetermined first direction; and
a function that stores the image data in predetermined region when the conditions of both the first function and the second function are satisfied.

4. The imaging data storage program stored in the non-transitory computer readable storage medium according to claim 3, wherein
the information terminal is equipped with a display section configured to display the imaging range of the imaging section,
the display section displays a first frame section indicating a position where the ruled line pattern and the gradation pattern are arranged within the imaging range,
the ruled line pattern and the gradation pattern of the test pattern do not overlap in the first direction of the imaging range of the imaging section,
the ruled line pattern is arranged on the near-side and the gradation pattern is arranged on the far-side in the first direction, and
the imaging section captures an image when the first frame section overlaps with the ruled line pattern and the gradation pattern.

5. The imaging data storage program stored in the non-transitory computer readable storage medium according to claim 3, wherein
the test pattern includes a direction display pattern for specifying the first direction,
the information terminal is equipped with a display section configured to display the imaging range of the imaging section, the display section displays a second frame section indicating a position where the direction display pattern is arranged in the imaging range,
the ruled line pattern and the gradation pattern of the test pattern do not overlap in the first direction of the imaging range of the imaging section,
the ruled line pattern is arranged on the near-side and the gradation pattern is arranged on the far-side in the first direction, and
the imaging section captures an image when the second frame section overlaps with the direction display pattern.
